(19) United States
(12) Patent Application Publication
(10) Pub. No.: US 2015/0288215 A1
(43) Pub. Date: Oct. 8, 2015

(54) CHARGER DEVICE WITH NETWORK CONNECTIVITY

(71) Applicants: GIGA-BYTE TECHNOLOGY CO., LTD., New Taipei City (TW); Gigazone International Co., Ltd., New Taipei City (TW)

(72) Inventor: Yaying Zhang, New Taipei City (TW)

(73) Assignees: GIGA-BYTE TECHNOLOGY CO., LTD., New Taipei City (TW); Gigazone International Co., Ltd., New Taipei City (TW)

(21) Appl. No.: 14/281,779

(22) Filed: May 19, 2014

(30) Foreign Application Priority Data
Apr. 3, 2014 (TW) 103205723

(51) Int. Cl. H02J 7/02; G06F 1/32

(52) U.S. Cl. CPC H02J 7/025; G06F 1/3234

(57) ABSTRACT

A charger device with a network connectivity including a base, a circuit board, a power connector, a wireless network transceiver, and a wireless charger module is provided. The base includes at least one electrical slot and a charging plate, where the electrical slot is electrically plugged with a mobile power source to be charged through the same electrical slot, and a portable electronic device to be charged is disposed on the charging plate. The power connector, the wireless network transceiver, and the wireless charger module are all disposed on the circuit board. The power supplied to the charger device is provided through the power connector. The wireless network transceiver transmits wireless network signals so as for the portable electronic device to access a wireless network. The wireless charger module generates an electromagnetic field which the portable electronic device is charged.

### CROSS REFERENCE TO RELATED APPLICATIONS

This non-provisional application claims priority claim under 35 U.S.C. §119(a) on Patent Application No. 103205723 filed Apr. 3, 2014 in Taiwan, R.O.C, the entire contents of which are hereby incorporated by reference herein.

### BACKGROUND

1. Technical Field

This disclosure relates to a charger device and, more particularly, to a charger device with a network connectivity.

2. Description of Related Art

The advance of technology has facilitated the development of more electronics with modern design. Among these electronics, a smartphone has, with no doubt, become an indispensable communication tool in our daily life. Although a smartphone, along with its many innovative accessories, brings convenience to our life, the battery of the smartphone, if frequently used for a long time, is likely to run low quickly, making a frequent charging of the smartphone much necessary.

It is common that an electronic device is charged through a power cord or data transmission cable. As a user possesses more electronics, he/she has to deal with the problems of managing wires between the electronics and the charger devices and inconvenience if the wires are lost. The inconvenience of wiring has led to the development of wireless charging.

In recent years, the wireless charging technology has been widely applied to consumer electronics. Wireless charging, or inductive charging, is built on Faraday's law of electromagnetic induction. Once a coil is charged, the coil will generate a magnetic field, and the corresponding coil is magnetically coupled and will respond to generate a magnetic field. The power, caused by the change of a magnetic field, is provided wirelessly to charge a small electronic device like a smartphone. One convenience of a smartphone is that the smartphone is able to get access to a network at any time. The smartphone can store data or transmit them from across the network. However, due to limited storage capacity inherent in a smartphone, a user has to delete some data or back up some data to a computer device to save storage spaces, causing inconvenience to use.

It is therefore useful if a smartphone can be charged in an easy way, and at the same time, the data in the smartphone can be backed up. It is demanded for a manufacturer to incorporate a personal cloud service to allow a user to remotely log in, through a smartphone, to exchange data between the smartphone and a client computer device or take control of the computer device.

### SUMMARY

This disclosure provides a charger device with a network connectivity to overcome the problems that conventional smartphones are charged through the power cord or data transmission cable and limited storage capacity inherent in mobile phones that often causes inconvenience to use.

The charger device with a network connectivity according to this disclosure includes a base, a circuit board, a power connector, a wireless network transceiver, and a wireless charger module. The base includes at least one electrical slot. The circuit board is disposed in the base, and the electrical slot is electrically connected to the circuit board. The power connector disposed on the circuit board, and the power required for the charger device is provided through the power connector. The wireless network transceiver is disposed on the circuit board and electrically connected to the power connector. The wireless charger module is disposed on the circuit board and electrically connected to the power connector, and generates an electromagnetic field.

In one embodiment, the electrical slot of the base is electrically plugged with a mobile power source so as for the mobile power source to be charged/discharged by the charger device.

In one embodiment, the base includes a charging plate on which a portable electronic device is disposed. Once inducing a portable electronic device nearby, the wireless charger module begins to charge the portable electronic device.

In one embodiment, the base is provided with at least one external connecting port.

In one embodiment, the base is provided with at least one button.

In one embodiment, the base is provided with at least one indicator light.

In one embodiment, the wireless network transceiver is selected from the group consisting of a Wi-Fi transceiver, a WiMAX transceiver, and a Bluetooth transceiver.

In one embodiment, the wireless network transceiver includes a near field communication (NFC) module.

In one embodiment, the base includes a receiving slot for fitting a storage unit. The storage, electrically connected to the power connector, is used to store data.

In one embodiment, the circuit board is provided with a processing unit. The processing unit, electrically connected to the storage unit, is used to transmit and process the data.

In one embodiment, the processing unit is operative to execute a wake-up procedure so as for a user to remotely log in, from the portable electronic device, to wake up a client computer device.

In one embodiment, the processing unit is operative to execute a control procedure so as for a user to remotely log in, from the portable electronic device, to take control of a client computer device.

The charger device of this disclosure charges a user's smartphone wirelessly, and, with the personal cloud service, the user can, at the same time, back up his/her data through remote access of the data in a fast and easy way. Additionally, the slot of the charger device provides the functions of charging and discharging the mobile power source.

### BRIEF DESCRIPTION OF THE DRAWINGS

The structure as well as a preferred mode of use, further objects, and advantages of this disclosure will be best understood by referring to the following detailed description of some illustrative embodiments in conjunction with the accompanying drawings, in which:

FIG. 1 is a perspective view of a charger device with a network connectivity according to one embodiment of this disclosure;

FIG. 2 is a perspective view of a charger device with a network connectivity, from different viewing angle, according to one embodiment of this disclosure;

FIG. 3 is a schematic view showing a charging of the mobile power source according to one embodiment of this disclosure;

FIG. 4 is another schematic view showing a charging of the mobile power source according to one embodiment of this disclosure;

FIG. 5 is a schematic view showing a charging of mobile power sources and a portable electronic device according one embodiment of this disclosure;

FIG. 6 is a block diagram showing a connection of the charger device, the mobile power source, and the portable electronic device; and

FIG. 7 is another block diagram showing a connection of the charger device, the mobile power source, the portable electronic device, and the client computer device.

### DETAILED DESCRIPTION OF THE PREFERRED EMBODIMENTS

Preferred embodiments of this disclosure are provided in this section, where the embodiments are exemplified by the charging of the mobile power source 200 and the portable electronic device 300 of the charger device 100 with a network connectivy. It should be understood by one skilled in the art that the embodiments are provided for illustrative purposes only but not intended to limit the configuration of the charger device 100, and thus the one skilled in the art should be able to change the disclosed elements to better fit different requirements.

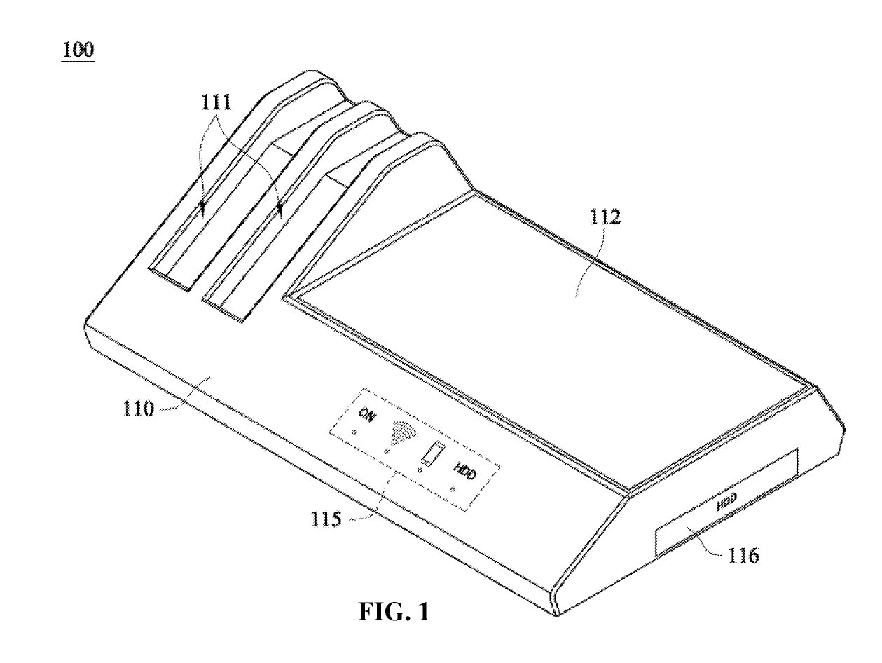

Referring to FIGS. 1-6, there are shown a perspective view, a schematic view of charging mode, and a block diagram of a charger device 100 with a network connectivity according to the first embodiment of this disclosure. The charger device 100 with a network connectivity includes a base 110, a circuit board 120, a power connector 130, a wireless network transceiver 140, and a wireless charger module 150. The base 110 includes plural electrical slots 111 and a charging plate 112. The electrical slots 111 are disposed on one side of the base 110, and each electrical slot 111 is provided for being electrically plugged with a mobile power source 200. The charging plate 112 is disposed on the top side of the base 110, and a portable electronic device 300 is disposed on the charging plate 112. The electrical slots 111 and the charging plate 112 can be monolithically formed with the base 110, or independent parts attached to the base 110. Depending on user's requirement, the number of the electrical slots 111 can be one or more than one, and the charger device of this disclosure is exemplified by, but not limited to, two electrical slots 111 in the embodiments that follow.

In the present embodiment, the circuit board 120 is disposed in the base 110, and each electrical slot 111 is electrically connected to the circuit board 120. The power connector 130, the wireless network transceiver 140, and the wireless charger module 150 are all electrically disposed on the circuit board 120, where the wireless network transceiver 140 and the wireless charger module 150 are electrically connected to the power connector 130 respectively. The power connector 130 provides the power required for the operation of the charger device 100 with a network connectivity. The wireless network transceiver 140 transmits and receives wireless network signals so as for the portable electronic device 300 to access a wireless network. The wireless charger module 150 generates an electromagnetic field so as for the portable electronic device 300 to be charged.

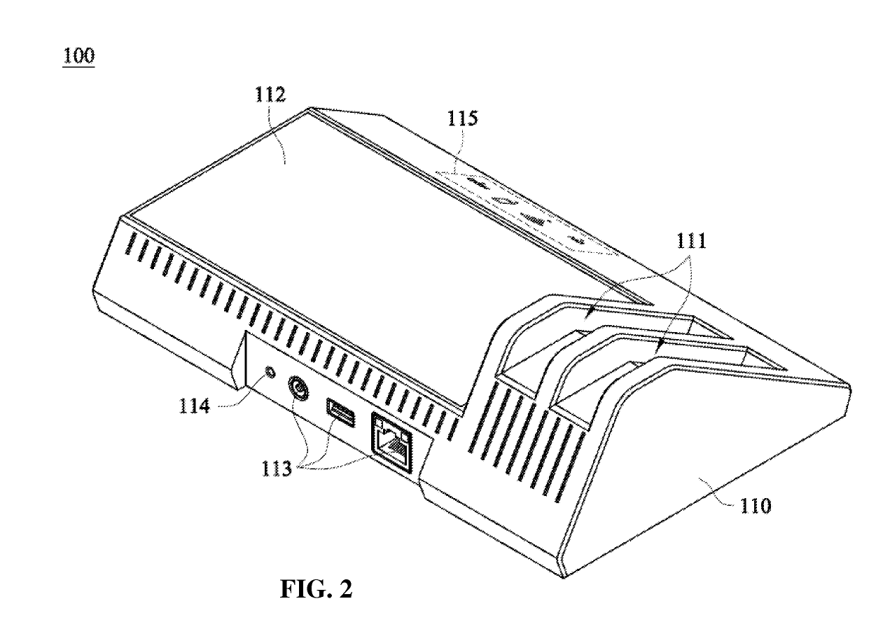

Referring to FIGS. 1 and 2, with respect to another embodiment of this disclosure, the base 110 is provided with at least one external connecting port 113, at least one button 114, at least one indicator light 115, and a receiving slot 116. The connecting ports 113 and the button 114 are disposed on the rear side of the base 110, where the connecting ports 113 may include a power cord socket, a USB port and/or a network socket, which are used to connect to a power cord, a USB cable and/or a network cable, respectively. The button 114 is a reset button for resetting parameter settings. The indicator lights 115 are disposed on the front side of the base 110. The indicator lights 115 are used to show current operation status, for example, power on/off, wireless network on/off, charging on/off, or HDD in place.

In the present embodiment, the receiving slot 116 is formed on one side of the base 110 for fitting a storage unit 160, where the storage unit 160 may include but not limited to an HDD, SSD, or SSHD. To better fit the requirement, the user can select, but not limited to, the type and specification of the hard disk and the type and the number of the external connecting ports 113.

The power connector 130 is in communication with a power cord through the external connecting port 113 (i.e., the power cord socket), and the power provided to the power connector 130 is supplied by an external power source (e.g., the grid-connected power). The power supplied to the charger device 100 is provided through the power connector 130.

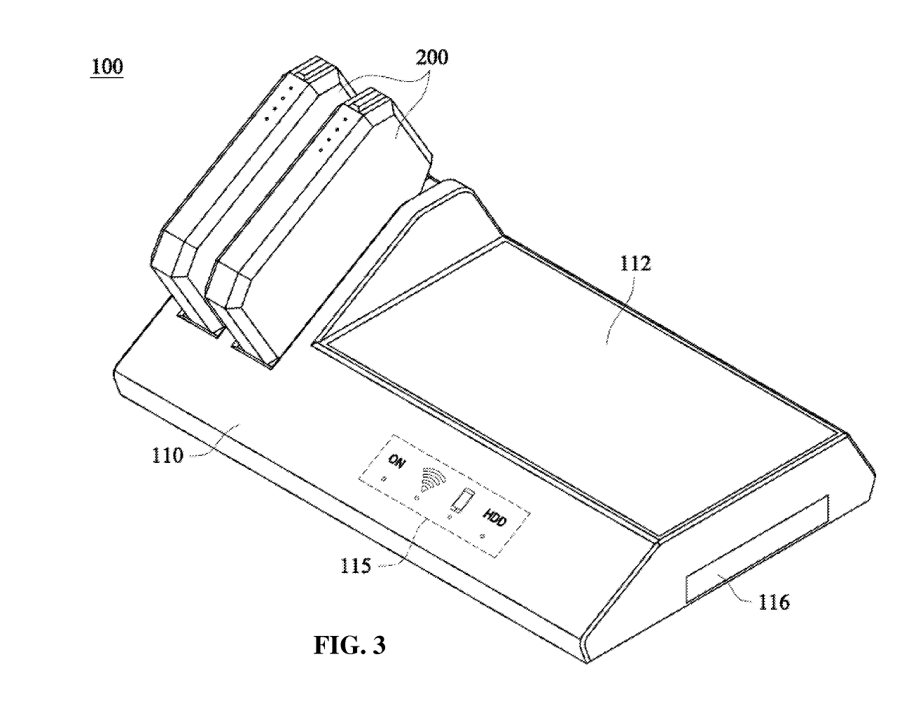

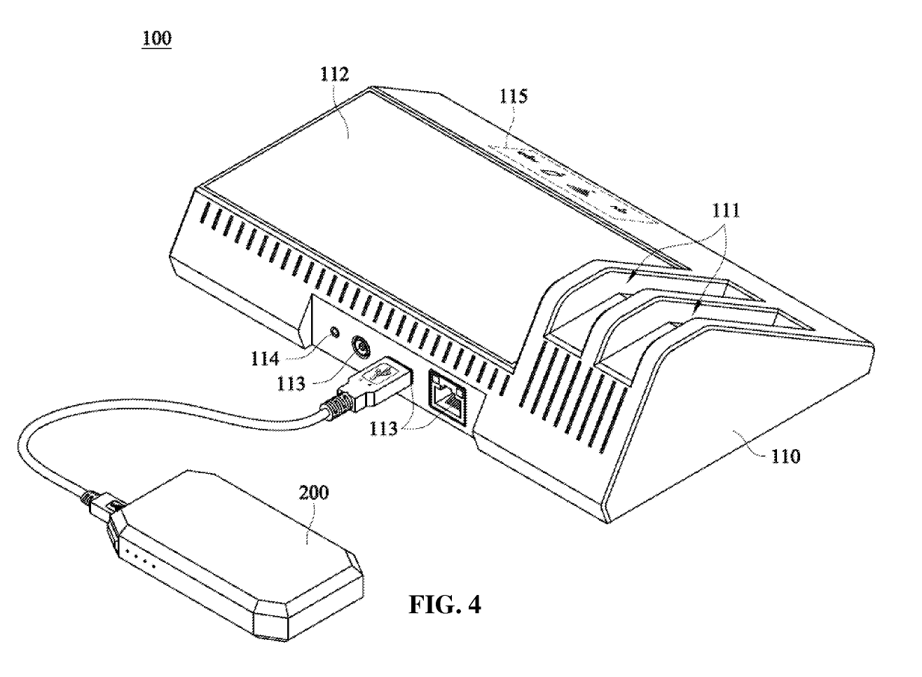

Referring to FIG. 3 or FIG. 4, the electrical slot 111 is provided with conductive terminals therein. When plugging in the electrical slot 111, the mobile power source 200 is electrically connected to the conductive terminals of the electrical slot 111 therein so as for the mobile power source 200 to be charged or to provide power (or discharge) to the charger device 100 with a network connectivity. In the present embodiment, as shown in FIG. 4, the mobile power source 200 connects to, through the external connecting port 113 (i.e., the USB port), the charger device 100 with a network connectivity through a USB cable for charging and discharging.

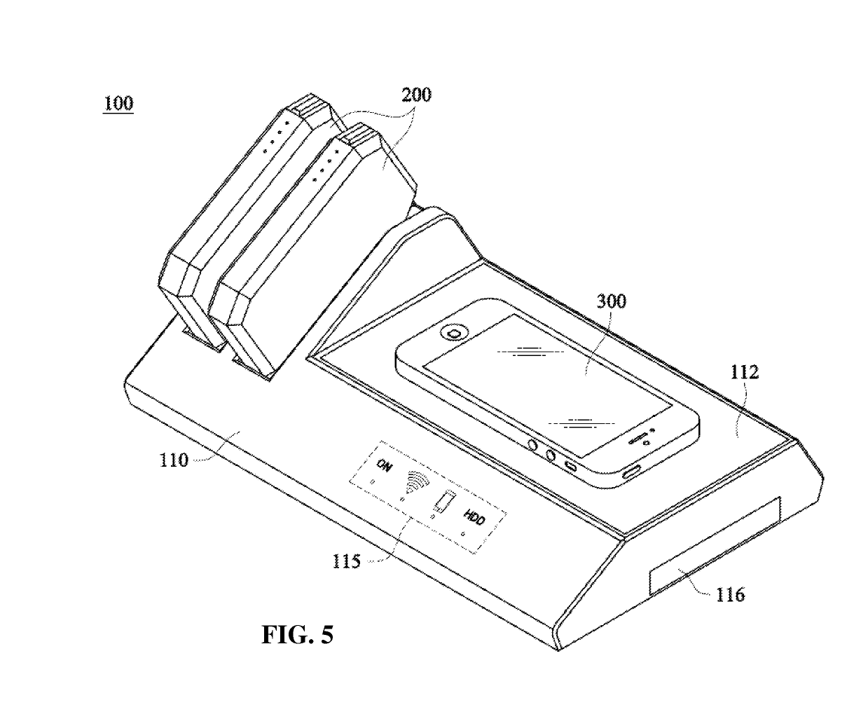

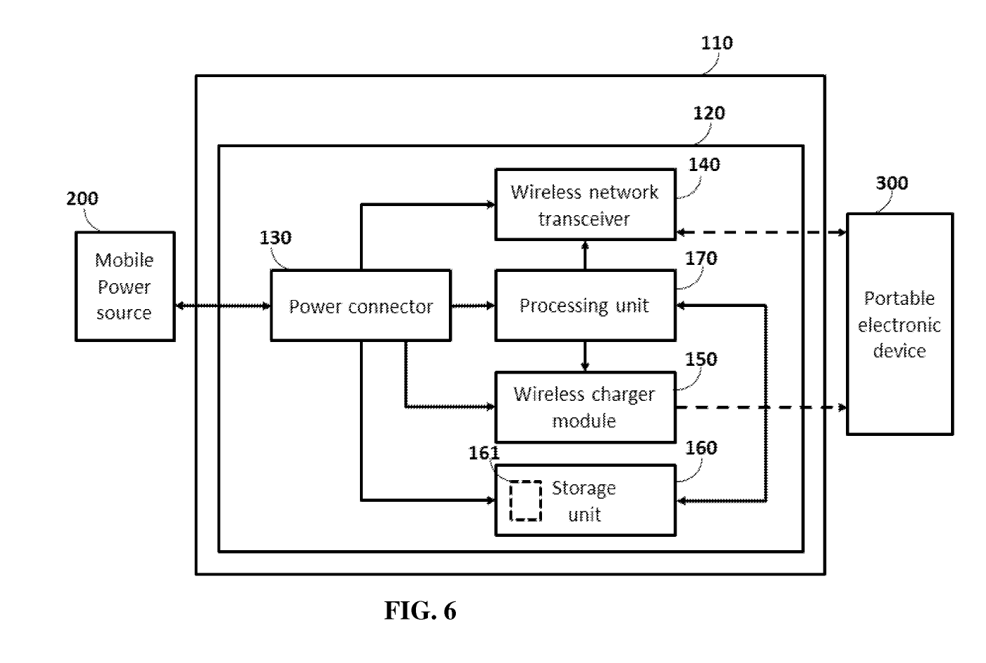

Referring to FIGS. 5 and 6, the portable electronic device 300 may be a smartphone, a tablet PC, or a computer device. The embodiments are exemplified by a smartphone. The wireless charger module 150 is disposed on the location corresponding to the charging plate 112, and the wireless charger module 150 generates an electromagnetic field induced from the current running through the power connector 130 or the external power source. When the portable electronic device 300 is placed on the charging plate 112, the internal circuit of the portable electronic device 300 generates an induced voltage by detecting the electromagnetic field, which is generated by the wireless charger module 150, and the induced voltage is further transformed into a current so as for the charger device 100 with a network connectivity to wirelessly charge the portable electronic device 300. The wireless charger module 150 may use a transceiver with 3 coils for wider charging span, facilitating positioning when charging.

To provide the personal cloud service, in one embodiment of this disclosure, the wireless network transceiver 140 may be a Wi-Fi transceiver, a WiMAX transceiver, or a Bluetooth transceiver. The wireless network transceiver 140 connects to an external network through the external connecting port 113 (i.e., the network socket) so as for the portable electronic device 300 to wirelessly connect to the network by way of the charger device 100 with a network connectivity.

In one embodiment of this disclosure, the circuit board 120 is further provided with a processing unit 170 electrically connected to a storage unit 160. The storage unit 160 is electrically connected to the power connector 130 for storing a user data 161, and the processing unit 170 is used to transmit and process the user data.

When the portable electronic device 300 is placed on the charging plate 112 for wireless charging, the wireless charger module transmits a sensing signal to the processing unit 170 so as for the wireless network transceiver 140 to enable the wireless network connection. At the same time, if the wireless transmission function of the portable electronic device 300 is enabled, data stored in the portable electronic device 300, for example, videos, documents, or photos, can be automatically backed up into the storage unit 160, after the wireless network transceiver 140 logs in the personal cloud's address and matches the settings. Additionally, the portable electronic device 300 is able to access the user data 161 in the storage unit 160 by logging in the personal cloud's address and matching the settings through a QR code scanning or manual operation.

Therefore, at the time when the portable electronic device 300 is being wirelessly charged, the data in the portable electronic device 300 can also be backed up without the hassle of wiring, making charging and data transmission as fast and easy as possible. Besides, the design of the electrical slot 111 provides both charging and discharging functions for the mobile power source 200. When a user is away from the office or home, he/she can take the fully charged mobile power source 200 as a backup battery for the portable electronic device 300. On the other hand, when power is out or there is no power source available, the mobile power source 200, if plugged in the electrical slot 111, can provide power to the charger device 100.

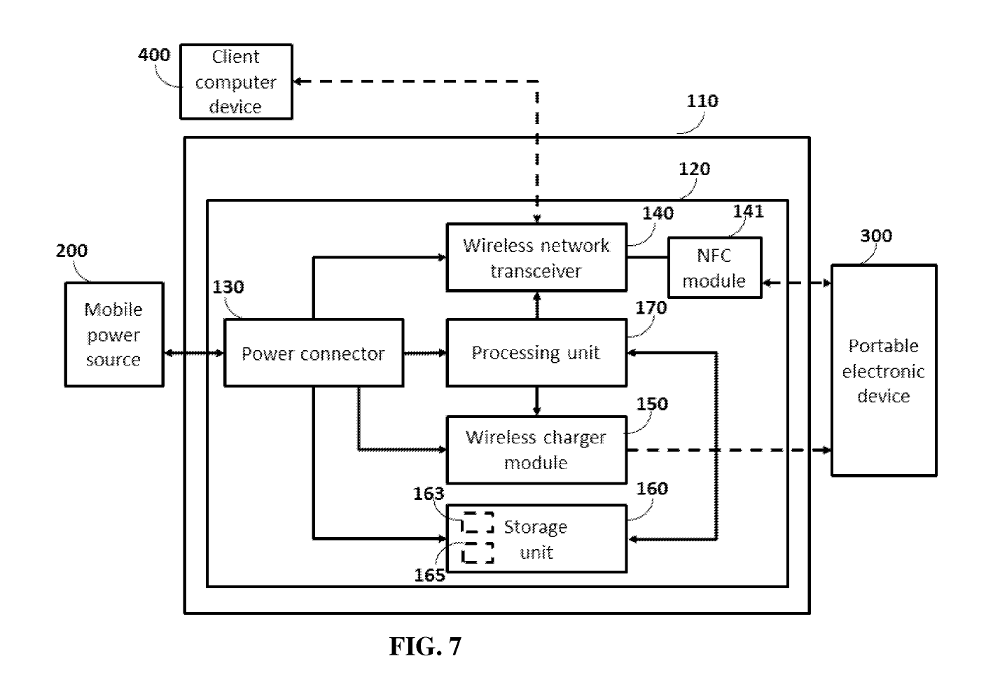

Referring to FIG. 7, the block diagram shows another embodiment of a connection of the charger device, the mobile power source, the portable electronic device, and a client computer device. In the embodiment, the wireless network transceiver 140 includes an NFC module so as for the portable electronic device 300, if located nearby within 10 cm, to exchange data with the charger device 100, enabling the data in the portable electronic device 300, such as documents, photos, or music, to be automatically backed up into the storage unit 160 of the charger device 100.

In the present embodiment, the storage unit 160 stores a wake-up procedure 163 and a control procedure 165. Once the processing unit 170 receives a wireless signal sent from the wireless network transceiver 140, the processing unit 170 is operative to execute the wake-up procedure 163 so as for a user, through the portable electronic device 300, to remotely log in a personal cloud's address, and once successfully logged in, the wireless network transceiver 140 is triggered to transmit a wireless signal to a client's computer device 400 to wake up the computer device. After the client computer device 400 is waked, the processing unit 170 is operative to execute the control procedure 165 so as for the user, through the portable electronic device, to take control of the client computer device 400.

It should be clear that, through the description of the embodiments, the charger device with a network connectivity of this disclosure provides a wireless charging facility to eliminate the wires between the smartphone and the charger device, and the charger device incorporates the personal cloud service to relieve the burden that the user needs to frequently delete and back up data due to limited storage capacity inherent in the smartphone.

In addition to wireless charging and data backup, the charger device with a network connectivity of this disclosure provides the functions of charging and discharging for the mobile power source through the slot. The charger device of this disclosure also includes an NFC function for fast wireless matching, making automatic data backup possible. Moreover, the charger device of this disclosure provides the functions of remotely waking up and controlling a computer device. In sum, the charger device of this disclosure achieves greater usability and user convenience, and therefore consumer use of the charger device is well expected.

What is claimed is:

1. A charger device with a network connectiviy, comprising:
a base, including at least one electrical slot;
a circuit board, disposed in said base, said electrical slot being electrically connected to said circuit board;
a power connector, disposed on said circuit board for providing power required for said charger device;
a wireless network transceiver, disposed on said circuit board, for accessing a network, and said wireless network transceiver being electrically connected to said power connector; and
a wireless charger module, disposed on said circuit board, and electrically connected to said power connector so as to generate an electromagnetic field.

2. The charger device as of claim 1, wherein said electrical slot is electrically plugged with a mobile power source to be charged or discharge by said charger device.

3. The charger device as of claim 1, wherein said base includes a charging plate for a portable electronic device being disposed thereon, and when said portable electronic device is induced, said wireless charger module begins to charge said portable electronic device.

4. The charger device as of claim 1, wherein said base is provided with at least one external connecting port.

5. The charger device as of claim 1, wherein said base is provided with at least one button.

6. The charger device as of claim 1, wherein said base is provided with at least one indicator light.

7. The charger device as of claim 1, wherein said wireless network transceiver is selected from the group consisting of a Wi-Fi transceiver, a WiMAX transceiver, and a Bluetooth transceiver.

8. The charger device as of claim 3, wherein said wireless network transceiver includes an near field communication module for performing data exchange with said portable electronic device.

9. The charger device as of claim 3, wherein said base includes a receiving slot for fitting a storage unit to be electrically connected to said power connector and store data.

10. The charger device as of claim 9, wherein said circuit board is further provided with a processing unit electrically connected to said storage unit, said processing unit transmitting and processing said data.

11. The charger device as of claim 10, wherein said storage unit stores a wake-up procedure, and the processing unit is operative to execute said wake-up procedure so as for a user to remotely log in to wake up a client computer device.

12. The charger device as of claim 10, wherein said storage unit stores a control procedure, and the processing unit is operative to execute said control procedure so as for a user to remotely log in to take control of a client computer device.
